(19) United States
(12) Patent Application Publication
(10) Pub. No.: US 2022/0329203 A1
(43) Pub. Date: Oct. 13, 2022

(54) Low-Profile Solar Panel (LPSP) for Vertical, Sloped, and Horizontal Installations with Convertible Multifunctionality and Appearance Adaptation

(71) Applicants: Thomas G. Cehelnik, Irvine, CA (US); Alexus N. Cehelnik, Irvine, CA (US); Thomas M. Cehelnik, Irvine, CA (US); Hunter B. Cehelnik, Irvine, CA (US)

(72) Inventors: Thomas G. Cehelnik, Irvine, CA (US); Alexus N. Cehelnik, Irvine, CA (US); Thomas M. Cehelnik, Irvine, CA (US); Hunter B. Cehelnik, Irvine, CA (US)

(21) Appl. No.: 17/715,023

(22) Filed: Apr. 6, 2022

Related U.S. Application Data
(60) Provisional application No. 63/171,712, filed on Apr. 7, 2021.

(51) Int. Cl. H02S 30/10; H02S 20/32; H02S 20/23; H02S 40/36

(52) U.S. Cl. CPC H02S 30/10; H02S 20/32; H02S 20/23; H02S 40/36; H02S 40/40

(57) ABSTRACT

The LPSP invention comprises an array of solar panel slats called solar slats along with inter-digitized filler slats. The solar slates on the outside can be open to the outside air or behind a covering window. The solar slats, filler slats or both types of slats can rotate or be fixed in angle position with respect to the sun solar angle. In a window shade application, the filler slats can rotate to avoid blocking the sun's rays from impinging on the solar slats. Alternatively, the filler slats can be transparent, or be adapted with electrically activated films (electroactive) to change the degree of transparency. The solar slats comprise structural material adapted with or containing photovoltaic material, even semi-transparent solar photo electric glass, and further comprising accompanying electrodes and wiring to conduct the generated electricity to an electrical load. The LPSP can be used as elements in a LPSP systems that folds and allows walking support such as a deck. The LPSP flips sides exposed to the environment to offer a different functionality.

### CROSS REFERENCE TO RELATED APPLICATIONS

This application is to receive the full benefit of U.S. provisional application number 63/171,712 submitted on Apr. 7, 2021.

### DECLARATION

Be it known that Thomas G. Cehelnik, Alexus N. Cehelnik, Thomas M. Cehelnik, Hunter B. Cehelnik, citizens of the United States of Orange County CA have invented a new and useful Low Profile Solar Panel. This non-provisional U.S. patent application incorporates by reference all content of U.S. provisional application No. 63/171/712 submitted on Apr. 7, 2021 and to receive the filing benefit of it.

### HIGH LEVEL OVERVIEW

This invention is a low-profile solar panel (LPSP) with adjustable solar louvers or solar slats mounted in a frame or other support structure. The solar slats are oriented to the sun to collect solar energy when adapted with solar panels to create electricity, heating, cooling, or environmental protection as a barrier. Filler slats may be included adjacent to the solar slats to fill the gap between solar slats. The filler slats and solar slats work together to the environment, to block acoustic noise and or light when the solar slats are pointed toward the sun. This feature even is available with the solar slats have no solar cells but are adapted to reflect or absorb sound and heat. The application and use of the LPSP invention can even be generalized and useful to protect structures and provide adjustable barriers to the environment weather moisture, hail, sleet, snow, wind. By adapting the slats with appropriate materials or it may be used as an absorber or reflector of physical environments, electromagnetic, thermal, etc. It may also be used as a deflector such as a wing, elevator, flaps, or airfoil or vent on aircraft or vehicle. This disclosure describes the most advanced features of the LPSP structure applied to a solar electric collector. The LPSP invention applies to any adaptation with advanced or less advanced and complex features described herein. This disclosure describes details how to adapt the solar slats for this purpose, but one skilled in the art can see from this disclose how to apply and adapt this invention to applications.

A useful feature of the LPSP is the solar and filler slats can flip to their opposite sides. Another aspect is the LPSP can close of the environment when the solar slats and filler slats are turned to make contact at an angle between them or simply close flat. In window and roof applications, a desirable feature of the slats is to seal out the environment such as light. To do this so the solar and filler slats are designed to overlap. To further seal the adjoining of the solar slats and the filler slats, particularly useful for the angular interface, and optional joining element is used that may comprise a strip, brush, or structure, such as a rubber door sweep strip, bristle brush, cloth overlay strip, or other material attached to both or one of the solar or filler slats to facilitate the sealing of the environment. Other applications such as decking or flooring, a gap between the slats is desired to allow for drainage or appeal.

The solar slats are slaved together with a rotating mechanism, and the filler slats are slaved together with a rotating mechanism. This allows each of them to rotate like individual blind shades that open and close the gap between them. Both solar slats and filler slats mechanisms may be coupled together or controlled independently with a motor/motors and linkages. Automatic, manual, or both options for controlling the slats is possible. This is done automatically by a computer-controlled motor system once activated by a cell phone, remote controller, or electrical switch on the LPSP, or manually by turning ON/OFF a switch to control the motor, or by a hand mechanical mechanism such as window blind wand for opening and closing. It is contemplated in one application for the LPSP to use string support and rotation system instead of a rigid frame. An interlaced string system, one for solar slats and one for filler slats, allows individual rotation of solar and filler slats, adjustment the length of the LPSP, and provide entire collapsing of the slats upon one another for travel and storage. In this case it can be attached to windows, walls, doors, or other supports that functions as frame support for the LPSP slats.

To open and close the LPSP with automatic control a computer with a program and a controller to provide control signals to the motors is implemented. When the solar slats are rotate independently of the filler slats, they are pointed/oriented toward the sun and track the sun with motor controller using a microprocessor running a control program. The program computes the best angle to the sun from the installed location. Then the user can open and close the filler slats to be able to see through the LPSP. This see-through feature of the LPSP allows users to see through in building in the use case when the LPSP is a window blind or shade. In the use case of a solar panel installation on a roof of a residential building, the see-through feature allows the mounting surface color to show through to make the panel appear more like the roof that that it is mounted on. In this roof mounted use case the filler slates may not even be desired or used.

It is important thought that the solar cells on the solar slats are protected from the environment to avoid damage from moisture. This can be done by a window glass or plastic adhered with glue or other material to cover both covering over the solar slats themselves or the individual solar cells used to make the slats. Alternatively, the solar slats can be boxed in with frame having a window on the front and or back to seal out environment as well.

The opposite sides of the solar slats and filler slats may be treated, covered, or adapted with other functional materials, structures, objects. Some examples include the painting or coloring or printing of signage, electronic signs or LED lighting, or LED signage, or texture such as grass or plants, artificial turf, or building material surfaces that match the mounting environment such as stucco, shingles, brick, stone. The filler slats may be adapted with light, heat, or sound reflecting or absorbing material to help insulate the environment between the front and back sides of the panel. The LPSP may also have a front and or a back covering to help seal out the environment such a rain and moisture. These covers can be made of transparent materials. When mounted inside a building as to outside, the front cover may simply be a window in building that the LPSP is installed. The back side is optional. When the solar slats and filler slat are flipped to the opposite sides in the flat position, the solar slats and filler slats themselves may be mechanically designed and supported to allow the user to walk or stand on the surfaces such as flooring or decking. This is where the benefit of treating the opposite side with materials such as grass, artificial turf, or brick or stone, or playground rubberized or other material surfaces. In this use case the front covering window may be instead placed on individual solar slats themselves or on the solar cells such a traditional glass covering over the cell semiconductors. Another useful implementation is to mount the LPSPs on a structure or support panels that can reverse sides in some manner, such as flipping, or rotating and expose the non-solar panel side having a useful surface covering such as grass, artificial grass, brick, stone, wood or metal decking, or other desirable surfaces. The support panel is designed to allows for people and animals to use the newly exposed surface for its other intended purpose, such as walking, standing, playing on the also provide the covering material including paint, LED displays, biological plants and organism, artificial turf, stone, stucco, etc. as desired for the intended use such as play surfaces for golfing or playgrounds, for landscaping or architectural purposes, for business purposes such a advertising ads and displays electronic and printed or other types, or for desirable appearance.

Additionally, the LPSP solar slats or filler slats or both type of slats front or back or both, can be used without any active solar energy collectors solar cells or water tubing or pipes, and instead just have desirable covering for making solar shades.

The sides of the slats can be covered with material of choice for such as acoustic sound insulation or thermal insulation. One side can be a thermally insulative material such as silver shiny looking foil to reflect light and heat covered bubble wrap for insulation and other a wooden looking material to look nice from outside when flipping sides, and from the inside when not flipped.

Alternatively, the LPSP structure may have some of its slats adapted with heat exchangers using convection, conduction or any method comprising one or more of the mechanisms. Examples comprise a heat exchanges such as liquid cool tubing, Peltier semiconductor thermoelectric engine, acoustic refrigerator, heatsink, fans, other even cooling methods such as evaporative cooling or radiative cooling.

Another unexpected benefit made possible with the LPSP design is as follows that is a novel, because the solar panels are pointing up toward the sun, so the sun rays are perpendicular or nearly perpendicular for curved surface solar cells/panels on LPSP solar slats or even filler slats to the face of the solar panels. Using this fact that, the LPSP solar slats and can be adapted with straws or tubes or rods. These tubes, or straws, for example green colored drinking straws or painted cardboard tubes from toilet tissue roles will become visible from the side, but still let the light pass through the tubes to the solar cells the LPSP. This feature allows the solar slats to appear as grass or have a color other than the color of the solar cells themselves. The thickness of the tubes is chosen to be an effective balance between being thin enough for structural support such as stiffness and adhesions surface area when gluing to the solar slat or solar cells while keeping the area of the tube ring or cross section area of the tube to as small as possible minimize the blocking of rays from the sun. The length of the tubes and colors and even textures are chosen by one using the invention for the coverage. Other geometric shapes are possible to accommodate the packing arrangement and the desired color and camouflage effects upon the solar cells.

Even tubes or rods of plastics such as clear or colored plastic such as Lucite material can be used and illuminated with light produces from a lights sources within the solar panel. These rods with the light sources can be used to function as pixels in a similar manner as a computerized display for signage. A microprocessor can be used to control the coordinate location and colors used in the pixels of the light sources chosen for illuminated. The LEDs or light source are controlled with wiring or circuit board wiring placed under the solar cells, a controller circuit, and transmitter and receivers such as RS232 or SPI, or I2C interfaces. Known waveguide properties and those skilled in the art of waveguides can make waveguides our of plastics or other materials that can be used to direct light up through the rods for people viewing the LPSP from the side or top end of the tubes. The lighting can be colored or white colors. Such approach embedding LEDs by themselves or LEDs of multiple color injecting light into the tubes, rods or other geometric shape that allow light to pass and reach the solar cells on the LPSP solar slats or any solar adapted fillers slates, or geometric shapes acting waveguide shape, into the solar slats surrounded by solar cells can make for a camouflage effect.

### STATEMENT OF FEDERALLY SPONSORED RESEARCH OR DEVELOPMENT

Not applicable

### REFERENCE SEQUENCE LISTING OR COMPUTER PROGRAM

Not applicable

### FIELD OF INVENTION

Field of this invention is solar energy in particular solar panels for building installation, particularly solar panels that can function vertically as windows. It also includes the field of window blinds and shades.

### SUMMARY OF THE INVENTION

This LPSP invention changes the way solar panels are installed in buildings because this invention makes solar panels function efficiently as windows with blinds or shades. The LPSP has individual slats or louvers that point toward the sun. It can close flat, flip sides, and does not shade the solar cells when operating within the effective range of solar angles. It allows for light to pass through the LPSP for viewing through it like a window or for showing the backing or other material while collecting. It also blocks off the light from passing through it like a window shade and this can be done while collecting solar energy.

The LPSP invention allows for more angled installations because the slats of the LPSP turn toward the sun. For example, parking garages equipped with LPSP can be horizontal roofed instead of sloped. Also, the LPSP can rotate to opposite directions and capture sun rays say from the south direction all the way to north direction. Can track the sun. This feature gives significant increase 10% or more of power when the solar cells of the LPSP have their surfaces essentially perpendicular to the sun rays.

The LPSP invention also has solar slat and option filler slats that fill the gap and for a wedge. The LPSP slats can be fixed in angle by design or rotatable and fold flat and even flip over to the other side exposing the opposite side of slats. The filler slat can be fixed in position and or rotatable. The filler slats can be adapted with solar cells also or other optical elements such as mirrors, electric controlled or mechanically controlled films or tint of coatings, or even transparent LED displays that can turn. When acting as mirrors light can be reflected from the filler slats onto the solar slats. The light that is reflected can be from other natural sources light or man-made and can be reflected from the ground or roof structures or other ancillary mounted mirrors or reflectors such as windows, with and without tint.

The mechanical architecture of the LPSP is such that it solar slats and optional filler slats can be used and adapted with materials of desirable physical properties such as thermal properties, acoustic properties, optical, or electromagnetic. The geometry works unexpectedly to absorb and reflect energy while close off the environment.

When used as solar panel replacements, the LPSP invention improves solar efficiency and while easing installation orientation-requirements and offers improved ascetic appearance on the building or installation area.

### BACKGROUND OF THE INVENTION

The low profile solar panel (LPSP) invention replaces traditional flat panel solar panel (FPSP) in horizontal and slanted (non-perpendicular) installations. The LPSP is advantageous over FPSP because:

it decreases the amount of active solar collecting area needed per panel by increasing the solar effective area of the solar collecting material.

Increases the solar panel efficiency when heated by the sun by providing quicker cooling to the solar energy collecting regions.

Operates in vertical mounted installations while providing a low profile relative to the FPSP of the same length;

Provides windows for to see thru;

Provides a barrier than closing-off of the environment including acoustic, light, and weather while collecting solar energy by using reflective absorbing wedges;

Flips sides to collect sunrise and sunset in vertical structure installations. Flips sides—and closes flat to allow advertising or change of appearance. Closes flat to keep out environment like a blind.

Rotates the solar collecting surfaces to the other side inward so the outward surface can have different surfaces exposed for blocking the physical environment such as light, and sound through absorption, reflection, and for providing aesthetics, or to turn off solar collection.

Provided cooled storage regions for heat exchanges, air conditioners, storage batteries, power converters, and greenhouse for plant and vegetation life.”

Flips sides to allow walking on such as a lawn or deck;

Provides fixed, adjustable, and trackable solar azimuth and zenith to increase effectiveness.

The LPSP has usefulness because most of the time in the day the sun is not directly overhead at a zero solar angle, occurring at the 12 o'clock position. Here we mean the 12 o'clock position is above in the vertical position. FPSP operate best when pointed so their surfaces (surface planes) are perpendicular, (or their normal vector is antiparallel) to the incident solar rays so they receive the most solar flux, number of photons per area of the active solar collecting surfaces such as photovoltaic solar cells, water heating panels, and building surfaces.

Most structures have roofs that are flat or at some incline angle. Additionally, buildings usually have 4 sides. For discussion, consider a hypothetical case where a building has sides facing east and west and the sun exactly rises in the east and sets in the west. Thus, two sides may receive solar rays with zero azimuth components measured from their normal vector, one east side for AM and the other west side for PM. In this case, a FPSP will receive maximum solar flux when inclined in zenith when its normal vector points antiparallel to the incident solar rays.

Most buildings have surfaces that are vertical on the sides, and roofs that are horizontal or at some slope. Thus most FPSPs mounted on building surfaces will need to incline FPSPs to receive the solar rays most effectively.

When possible a solar installation will point at preferred azimuth to help maximize its solar flux. This can be done by rotating the solar structure to the preferred angle. It can be tracked, adjustable or fixed in azimuth. If it is fixed, then the zenith angle can be optimized by inclining the FPSP to maximize the solar flux. The zenith angle can also be tracked to the sun, adjustable, or fixed.

The optimum azimuth and zenith angles to achieve optimum solar flux for FPSP occurs when the solar rays are at normal incidence. The values of the azimuth and zenith angles to the sun are typically averaged over some amount of time such as a year, season, month, day, or hour for the latitude and longitude of the installation.

Ephemeris tables and online calculators are available to compute the direction in the sky to point the normal vector of a solar panel (vertical solar angle), to receive the maximum average solar ray exposure or cumulative solar flux for a geolocation, date and duration of the average.

FPSP installations in azimuth are usually constrained by the orientation and architecture of the building. FPSP orientations in zenith can be driven by convenience of mounting surfaces such as a roof. The azimuth orientation of FPSP is usually chosen on residential installations so the FPSP lies parallel to the roof while being offset by spacers. In some residential and more so commercial buildings with flat roofs they are inclined. On any building or structure vertical mounted FPSPs are not common on sides of buildings unless inclined which extends them outward from the building.

Inclining a FPSP to a zenith angle on roofs, or sides of buildings and on vertical structures may not be practical for available space, aesthetics, weight, and structural strength limitations such as wind and snow loading.

In addition to the above stated reasons, FPSPs are not very useful when mounted vertically because the solar rays are mostly from high in the sky which are at low solar angles relative to the vertical. Under these conditions the solar flux received by the panel is small, since the effective area Aeff of the solar panel is its physical A times the cos(90-phi), where phi is the zenith angle measured from straight up or vertical direction.

When a FPSP is positioned vertically, its effective area is smaller than the physical area A; it catches less power from the sun rays per physical area A of the FPSP. Operating a FPSP in this condition uses the solar collecting material ineffectively.

Since the FPSP is used inefficiently in the vertical installations, more solar collecting material and surface area is necessary to achieve the same electrical power output compared to when the solar rays are normal to the FPSPs. What is needed is a LPSP that effectively uses the solar collecting material.

If a FPSP is tilted and extended outward from the building, its efficiency increases and more power is output. The extension or wall offset of a FPSP of length L tilted to receive solar angle phi measured from the vertical is L times cosine of phi. For FPSP of length L of 6 ft with a solar angle of 30 degrees means the 330 extension is 6 times 0.866 or approximately 5.2 feet. This is quite large for placing on the side of a building and placing these on the side of a skyscraper can present structural integrity challenges. Thus, what is needed is a LPSP to reduce the offset when installed vertically.

FPSPs used on shade structures such as parking covers mount flat on a sloped roof structure. The sloping complicates the design of the building. These installations are fixed in azimuth and zenith and thus face and collect solar rays in one direction. Solar rays from other directions are collected inefficiently by the solar cooling material. What is needed is a LPSP that lays flat on flat surfaces such as roofs and or reduces the needed incline. The LPSP also needs to receive solar rays at angles throughout the day and in both directions for AM and PM collect.

FPSPs used on shade structures have in some designs use translucent spaces between their solar cells. These spaces allow for some light to pass to provide illumination underneath the FPSP. These spaces are small in width compared to solar cells to avoid reducing the area the active area of the cells. These spaces do not provide enough width to allow a user to see through it like an open window blind. They are also closed that keeps out the environment. What is needed is a solar panel that is see-thru and closes off the weather.

FPSP structures are fragile, and occupy space on roofs that prevent the area from other uses. For example, there exists commercial flat panel installations that are arrays or rows of inclined FPSPs. Also, using FPSPs in ground installations in residential communities tend to occupy yard space otherwise used for agricultural/gardening areas, playgrounds, or landscaping. This FPSP installation reduces useful yard or roof space and precludes other activities such as sports and gardening. What is needed is a LPSP that has dual purpose for playing and solar collecting.

In residential communities FPSP on roofs tends to reduce aesthetics and thus reduce the curb appeal on the residence. Thus, what is needed is a Low profile solar panel (LPSP) that blends in better with the roof and mounting area.

Thus, what is needed is a Low profile solar panel (LPSP) that when mounted vertically reduces the extension or offset of a FPSP for the same solar angle while producing the same or more power.

Another need of a LPSP is to have see-thru windows or openings to allow diffuse light to pass through.

FPSPs also have large unshaded surfaces on the solar panel. This is good for receiving maximum solar flux, but the panel efficiency of photovoltaic solar panels can be reduced due to heating from the sun exposure. Heat is the flow of energy from hot to cold temperatures. In solar heating applications the flow of heat out from the panel to heat exchanges can be slower because the entire solar panel is raised to the same temperature. What is needed is a LPSP that increases heat flow from the solar cells and between heat exchangers.

FPSP provides cooling shading underneath the panels to air by preventing solar rays from heating the region underneath. FPSP mounted vertically on a build have solar collecting limitations discussed above. When installing them flat over a window opening or window, they will not offer cooling to the window or interior. In fact they will usually heat the building by heating to temperatures equal to the glass or interior. This is because thermal conductivity is similar or larger to the window or air in the opening; and because the panel is at the same temperature over its physical area. So, what is needed is LPSP that can cool the window or air in an opening that it covers.

The invention of the LPSP addresses the needs above in some unexpected ways.

Features of the LPSP:

Some of the features of the LPSP are as follows, where it:

Captures nearly the same amount of power as a FPSP used in an ineffective way, using less solar collecting material and a low profile.

Uses solar slats to capture solar rays at or near normal incidence to increase the effectiveness of the solar collecting material.

Reduces the amount of solar collecting material and the weight per panel.

Provides see-thru window opening.

LPSP is to open and close to keep environment out such as sound, light

Provides cooled regions.

The LPSP should also be usable on inclined installation roofs or structures, and operate horizontally.

This invention disclosed herein is a LPSP that has some or all of the following aspects in various orientations.

### ASPECTS OF THE INVENTION

Aspects of the LPSP invention are:

Functional Features:
1) The height of the LPSP is less than the maximum standoff of a traditional single flat panel of the same length oriented perpendicular to the sun rays when mounted vertically. For example, if a traditional panel of length=x meter is mounted at an angle of alpha between the plane of the panel and the plane of a vertical wall, the maximum standoff distance is given by x*sin(alpha). The LPSP comprises a plurality of solar slats.
2) The LPSP blocks or restricts the penetration of the weather or environment from one side of it to another by using an existing building window or by included its own barrier such as by a window or sheet of material. The LPSP may comprise a plurality of windows or barriers as an option such as in front, back, between or even segmented channels to partition air for cooling and heating, and to provide safety-barricades. Sides are an option to seal out the environment or to allow for designed venting of air flow for cooling or environmental controls.
3) The LPSP collects energy while also provide windowed sections. The windowed sections can be due to physical opening of a gap between solar and filler slats. The windowed sections can change transparency and/or an opaqueness thus providing the functionality of a window blind that opens and closes. The blind can be opened mechanically by moving filler slats or use electrically controlled optically material placed on transparent sections or all filler slats. This approach allows electricity to be used to control the LPSP transparency either provided externally by a power source such as a battery or mains electric or provided by the solar cells in the LPSP allow light to pass or be blocked by electricity viewing or closed for privacy or to block out the light. The color of the filler slats may also be changed by the electrical material. These may even be organic LED computer displays panels that allow see-through screen capability.
4) The option exists to make the solar slats open and close flat as window blinds by including filler slats, and rotate both type of slats, solar slats or filler slats. The solar slats or the filler slats, or both can flip to the opposite side to change the appearance, allow them to cool, to turn-off the solar cells, change the LPSP functionality such a signage, or to protect the solar panels or its comprising components from the environment.
5) If the area behind the solar-slats and filter slats needs physically closed off to separate the environment in front from the back, the filler slats can rotate and make contact or overlap the solar slats. This allows the solar slats to still point toward the sun but the gap between them is filled. This is useful for thermal temperature control of the solar panels, offer insulations of sound change optical features to name a few.
6) In the case of electrical power, the solar panels ability to generated energy from the sun is shut-off by a control switch either electrically by a switch or semiconductor or mechanically by pointing them away from the sun.
7) In some instances when the solar angle (in zenith) is outside the intended design range, shadowing can occur on the solar slats. When the azimuth is aligned with the sun location, the LPSP shaded areas on the solar slats occurs in strips. This shading can also happen if the filler slats are not used, and only solar slats are used in a design that closes flat but has minimal gap when closed. The LPSP makes use of this shadow profile to combined more effectively the power from solar cells.

Physical Features;
1) The LPSP comprises a single or plurality of solar slats in a frame. Array of frames is possible to make the LPSP structure. The solar slat(s) may rotate, or the frame may rotate, or both may rotate to align the sun's rays perpendicular or nearly perpendicular to the solar cell surfaces to achieve an effective collection of energy for the application. The rotation of the frame may be in either or both azimuth and elevation. The solar slats rotate in elevation. Note, the frame needs to rotate less in angle the elevation direction when the solar slats are rotatable to make the sun rays perpendicular to the solar slats solar cell surfaces or effective surface area when curved.
2) The minimum spacing of the frames and solar slats is chosen at the solar angle from vertical or the zenith, called the “solar design angle” or just the “design angle” at which the frames and solar slats produce no shadows on one another.
3) At the design angle, the solar slat orientation is such that the solar slats are oriented perpendicular to the sun rays. In the case of curved solar cell surfaces on the solar slats, the orientation is such that the rays are mostly perpendicular at the specified design angle of the sun from the vertical.
4) A cover or window that the frame mounts into for providing appearance effects and protecting solar slats from the environmental elements. This cover may be adapted with coloring or pattern design to match or blend into the installation environment.
5) Optional back cover for the frame providing appearance effects or some amount of transparency for vision. The back cover allows the LPSP to be sealed together to form a box with the front cover, a frame with sides like box, and the back cover. A single solar slat in a frame can be put in the box or a plurality of solar slats with optional filler slats.
6) An optional intermediate filler slats that offer a physical environment light, heat, between the solar slats.

### BRIEF DESCRIPTION OF DRAWINGS

FIG. 1—Shows a) the low profile LPSP reduced offset from the vertical mount, b) the offset from vertical for the flat panel FPSP. a) Shows a vertical array of solar panels separated at the minimum separation to avoid shadowing. The solar slats (200) are supported by a mechanical support that can adjust the solar angle phi ϕ (19) by pins or dowels or tubes that can even function as an electrical conduit attached to a frame (18). b) shows a traditional flat panel solar panel (FPSP) with offset from mounting of X. The ratio wall offset to height X/Z is larger for FPSP than a Low-Profile Solar Panel (LPSP) shown in a).

FIG. 2—Shows the offset calculation for an even number of solar slats for LPSP and FPSP. For a LPSP the offset divided by the length (X/Z) is less than that of a FPSP.

The gap G dimension is also calculated. See the gap illustrated as G in FIG. 1

FIG. 3—Shows a) the front of the LPSP when closed without optional filler slats shown, and b) shows side view with solar slats (200) without optional filler slats. The filler slats (201) are not shown for clarity but can be added with information in this disclosure by one skilled in the art. The Front cover (103), and back cover (101) are shown along with slat supports (19) and frame (18).

FIG. 4—Shows a) a solar slat comprising solar material (110), on a circuit board (12), electrically wired with wires (15) that are routed to or along the rotating shaft or through a conduit (30), with shield connection (31). The windows front (103) and back window (101) in this case are held together and sealed with gasket (13) and thread area or sleave (34), by fastener (17).

FIG. 4—shows b) staves of series wired solar cells to add voltages. These staves run along the width L of the solar slats (200) so shadowing due to solar slats being blocked will not completely cut off the circuit and cause electrical loading to other staves. The Stave outputs are condition with a voltage control circuit (not shown) to fix the voltages before adding the stave output power/current in parallel. The voltage control circuits are not show but can comprise voltage regulator, voltage boosters or step-down voltage DC-DC convertors.

FIG. 5—Shows a sideview of the vertical LPSP implementation with filler slats (201). The implement shows a normal solar blind slat (202) adapted with solar slats (200) offset at an angle to make the solar slat assembly (ASY). The solar slats are fixed at an angle or adjustable in position simple case for an orientation for a preferred season and geographical location. FIG. 5 also shows the gap dimension G when looking through the LPSP. The gap G changes dimension when it is opened and closed as shown by the equations. The gap needs to close off or block the light when the LPSP functions as a blind to prevent light from coming through. The filler slat (201) needs to not block the light from the solar slats but closed so light does not come in to the room, thus there needs to be overlap of the slats. This design does not fold flat or flip to the side easily unless we reduce the angle beta by folding the solar slat (200) in. Also, the volume of the shaded area underneath the solar slat is not closed off which reduces available storage in cool areas. This may impact or degrade the thermal convection air flow from heat rising form solar slats. Also, Acoustical absorption and reflection and light is best absorbed when there are multiple reflections or bounces of the rays from wedges. Wedge shaped design performs better. Using the filler slats in wedge allows the tiller slats to extend and even be adapted with rods like grass or wires that will not block the light because they are thin and essentially run parallel to the sun rays.

FIG. 6—Shows a front top view of a mechanized LPSP solar slats (200) and filler slat (201). A plurality is possible. Window covers front (103) and back (101) are not shown in this implementation. Frame elements (18) and supports (19) are used to connect the axials of the slats (not labeled). The axles of solar slats (200) and filler slats (201) are coupled to a linkage (602) that mechanically couples to motors (600). Computer and motor control is not show. They have a battery supply, separate solar panel supply or house electrical supply that also provides power to the computer, controller, and motors (600). The slats move so they can turn with filler slats (201) from blocking the sun reaching the solar slats (200). A computer program adjusts the angle of the solar slats (200) and filler slats (201), so the solar slats surfaces are perpendicular to the sun rays for a geographical location of the LPSP installation. When these slats are overlapped to provide support and avoid environment leakage through the LPSP slats, the slats (200), and (201) must be turned in opposite directions or in an independently manor to avoid latching up on rotation. It also shows slat supports (80) that fold up to bolster and support the slats so when they flip to the other side or have covers front (103) or back (101) they can be walked on. Once the slats are flat the supports fold into place as studs. The supports (80) are attached to the frame and can be manually position in place or by a motor with a mechanical linkage or drive system, and controlled by a switch, or switch with a sensor, or a sensor to control a switch and even a computer to read the sensor or switch and control a motor by sending signals from a controller to the motor drive.

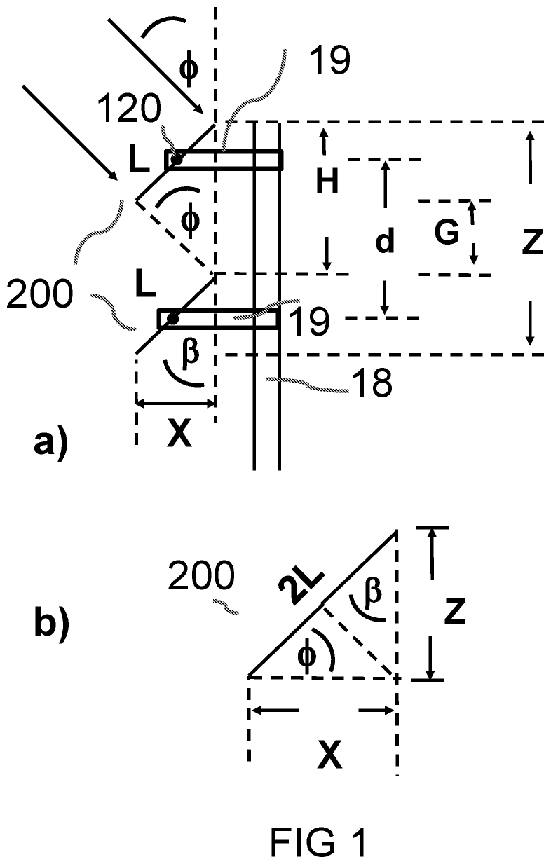

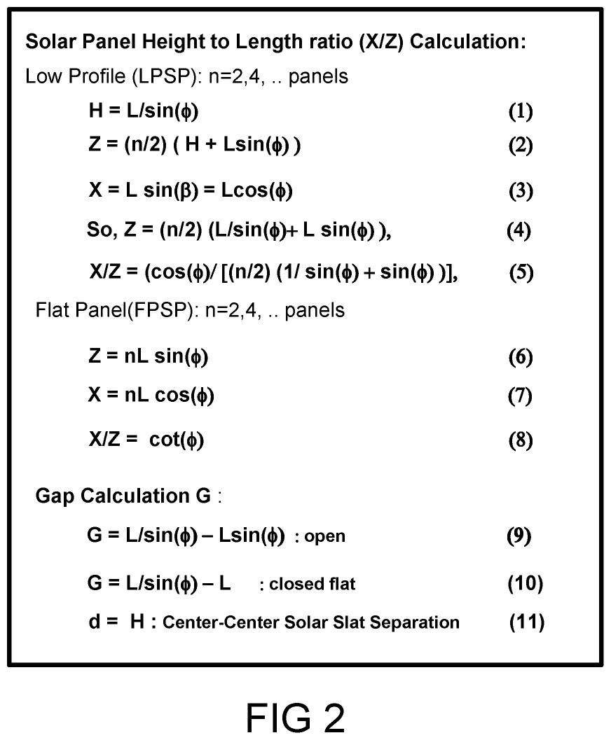

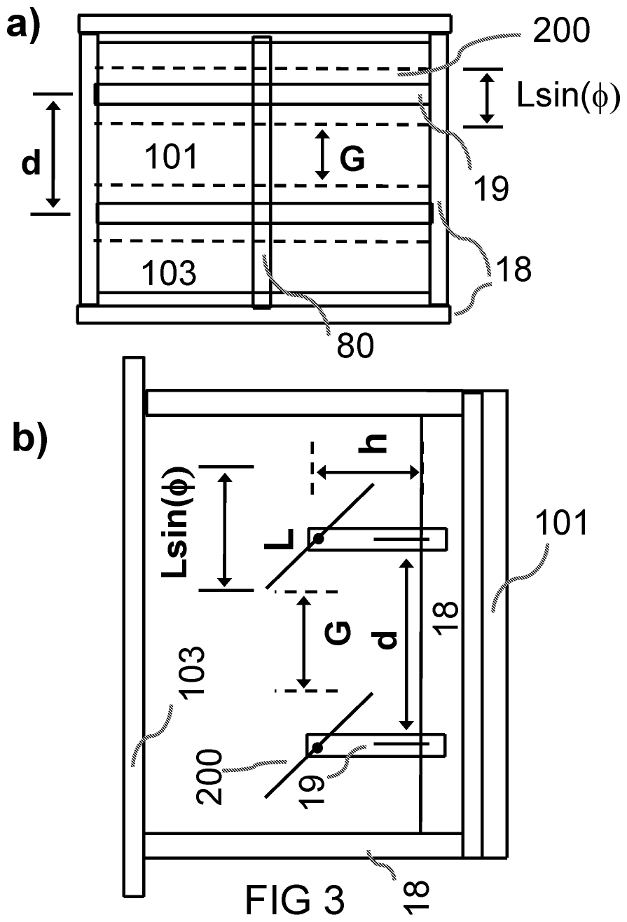

Alternatively, the solar slats are rotatable using a motor in the ASY to point in at a preferred angle at any time commanded by the computer and controller. This configuration blocks light through the gap while collecting solar rays at a single angle by closing the filler slats (201) against the solar slat (202) of the solar slat ASY. The filler slats move independently from the solar slats ASY to open and close the gap. Note, as the solar slat ASY rotates the gap will only fill if there is overlap between the filler slats (201) and solar slat (202). A feature of this LPSP invention is providing the overlap by making the filler slats longer to extend beyond the solar slats (202) in this beta angle not equal to zero in this case, or beyond the length of solar slat (200) when the angle beta is zero. Note when the angle beta is not zero, it has the advantage to help cool the solar cells on the solar slats (200). This is another feature of this invention.

FIG. 7—a) Shows the LPSP with solar slats (200) base structure (100) made as overlapping material or molded for cut as a single piece. The axial conduit (120) is shown. The dimensions for the design are indicated. FIG. 7-b) Shows the filler slat dimensions, the filler slat base structure (102), and the axial conduit (121). The axials can be solid if not used to run wires and if using wires from the slats can even be attached to the axial to route the wires. The wires route to the voltage control circuit and are combined. The wires from each solar slat (200) or even filler slat (201) if having solar cells attached connects to a voltage controller mounted on the slat itself or elsewhere on the frame. The wires from outputs are routed through, on, or inside the frame as need to combine. Since the current is larger the wiring that carries the combined power from the slats to the output is of larger current handling capability, or larger in diameter. Buss bar or buss wiring is also possible to used instead of individual wires. Insulation and grounding needs to

[symbol]

FIG. 8—Shows a) LPSP slats interlocked with solar cells (110) on top and synthetic grass covering (111) on the bottom. FIG. 8 shows b) with slats flipped over to expose the grass covering (111) on the top. Other materials are possible to be used for the covering.

FIG. 9—Shows slats when not laying flat. a) shows the orientation at the design angle, and b) shows it when at the maximum angle when the solar slats (200) with base (100) that just touch the filler slats (201) with base (102). The filler slats are made longer in this design, so the sun is not blocked from the solar slats (200).

FIG. 10—Shows the filler slat separate Q that needs filled by filler slats for a LPSP at an inclination angle alpha. The filler slat design is made with a computation of Q, so the gap is filled.

FIG. 11—Shows design equations and a method for computed the design parameters for the LPSP.

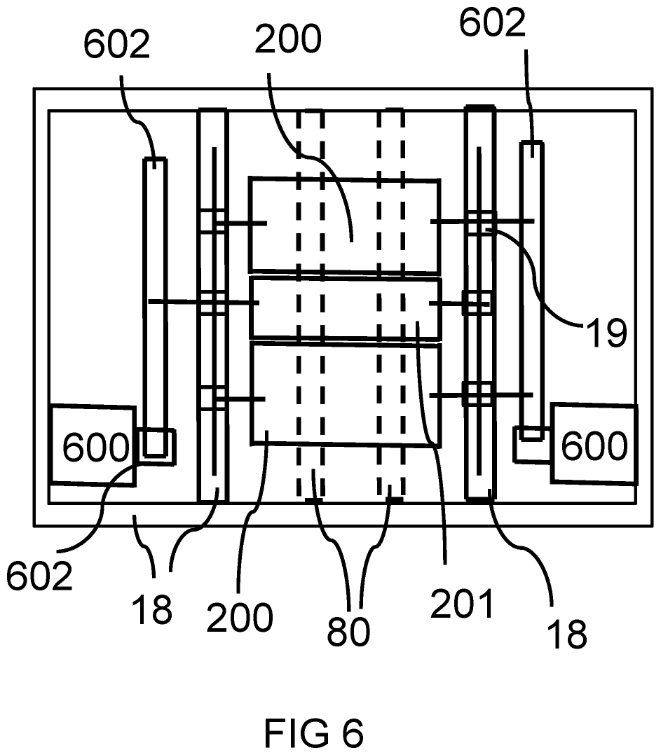

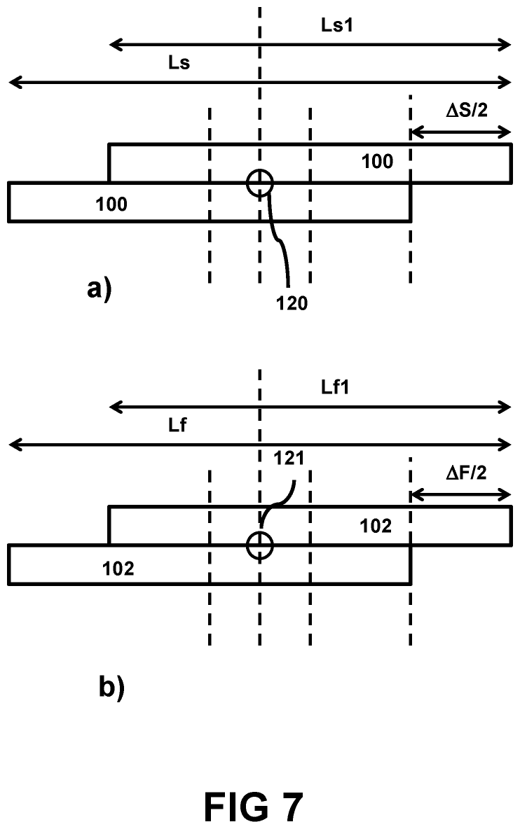

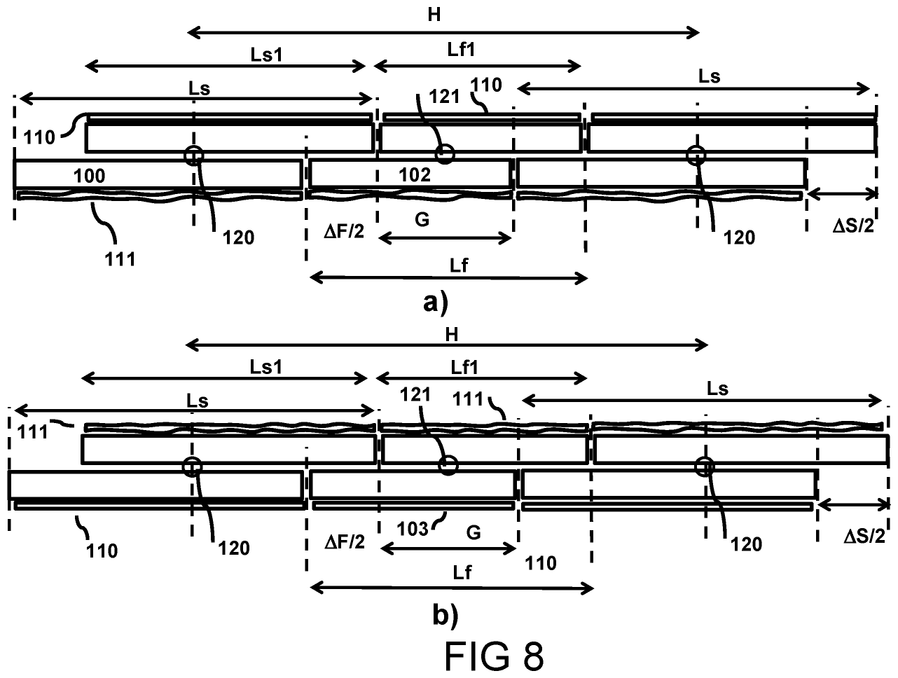

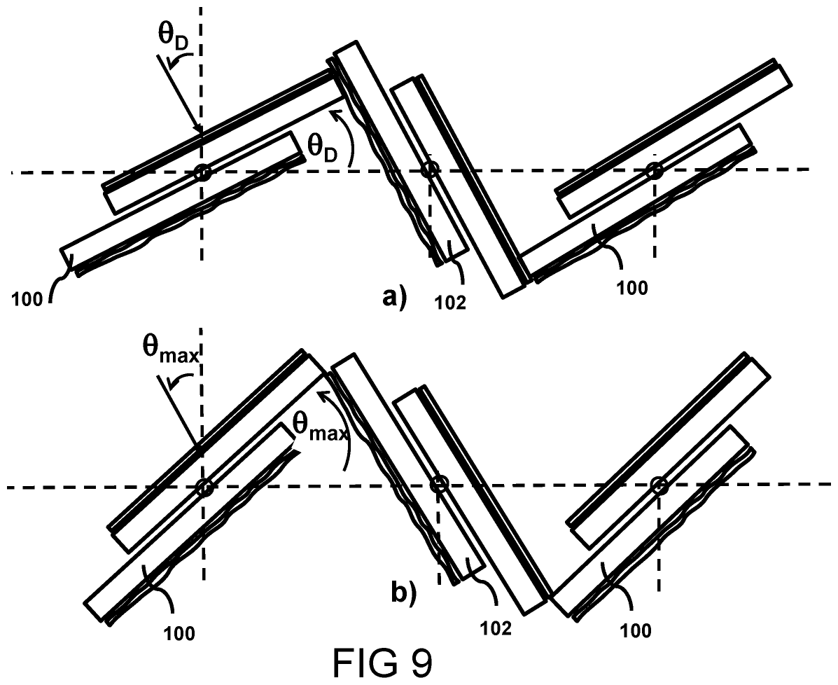

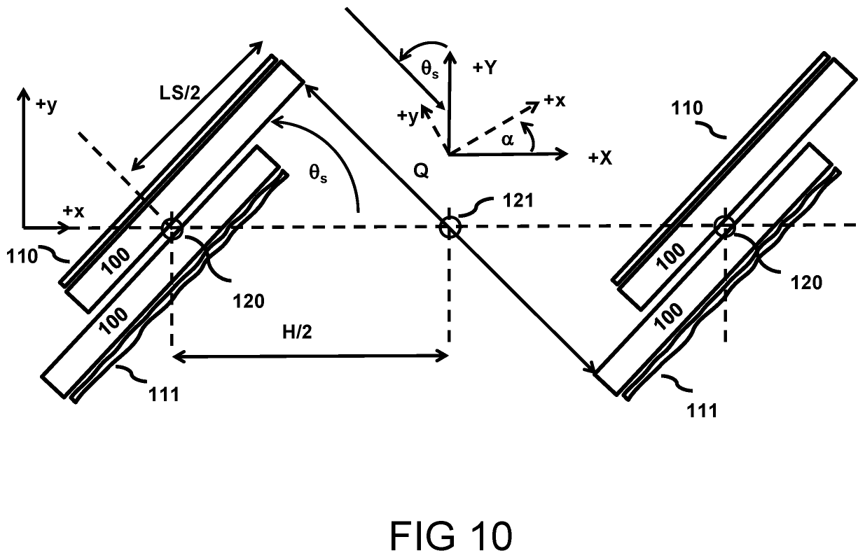

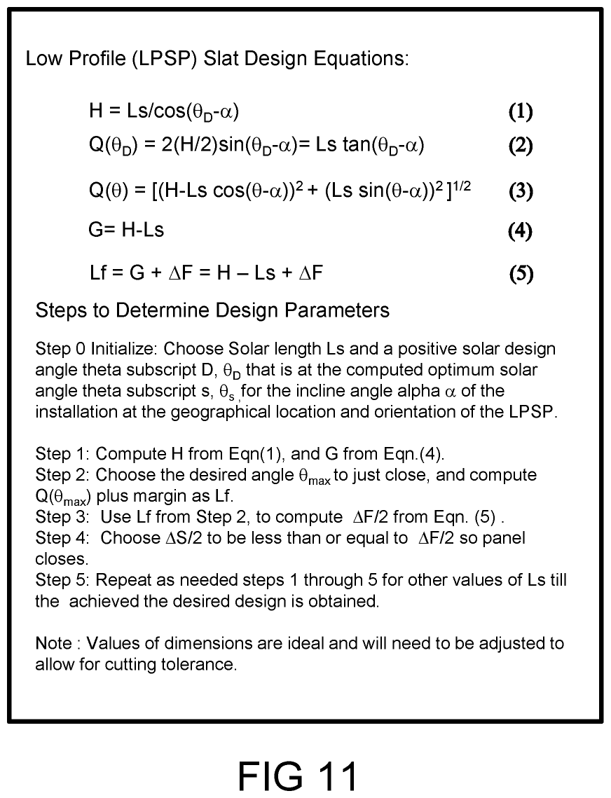

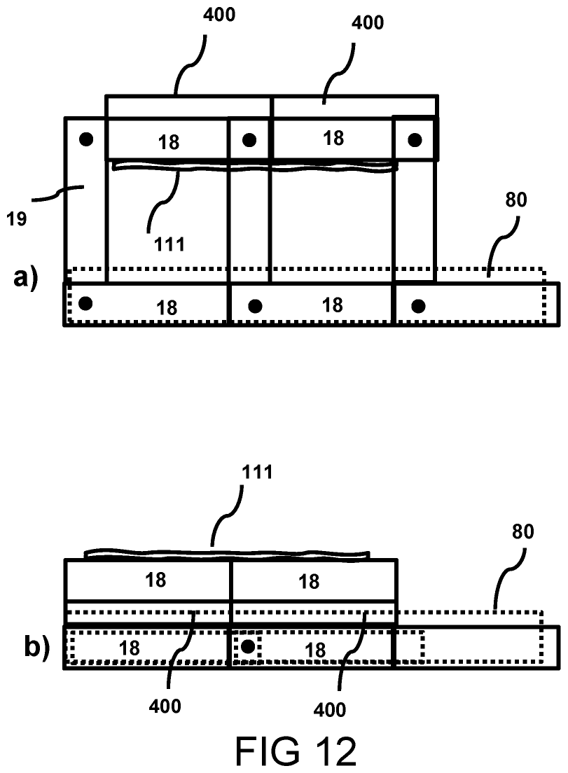

FIG. 12—Shows a horizontal LPSP system that allows for walking as a deck or sidewalk. FIG. 12 a) shows the state of collection solar energy, and b) shows the folded state of enjoying the beauty and functionality of the surface (111) as a deck. LPSPs used as (400) are ideal for this geometry. However, FPSP flat panel solar panels can be used, and the frame structure can be changed to accommodate angular orientations needed for FPSP usages as (400). The frame of the LPSP system can be recessed into the ground or floor, or the ground may be built up. This way, a flat walking or flush surface is available. The LPSP are shown as (400), with frame (18), and supports (19). The bottom surface (111) is treated with a coving such as synthetic grass or real grass sod. The frame (18) folds to flip sides of the LPSP. Mechanical support is provided by frame (18) and frame studs (80) that may be fixed as part of frame (18) or rotate into place as in FIG. 6. To keep biological coverings alive in sun the frame can be adapted to allow light or reflect light or use artificial lighting with a useable spectrum for plant growth. Light can also pass through the LPSP (400) with filler slates leaving an opening or not present at all. The sod or biological material (111) can be placed in strips to allow a gap for light to pass through the gaps of (400) and imping on the bottom frame (18) that is adapted with mirrors (not shown) or reflective elements strategically placed to reflect the light up to the covering (111). The lighting can be powered externally or be powered by the solar power from the cells. Water can be provided by cooling tubes options (not shown) that cool the solar cell panels. Alternatively, sprayers like in a grocery store on vegetables, or water sprinklers or drippers can be placed on or contained in the frame. Alternatively, support for the panels such as element (80) in FIG. 6 can be used to have drippers that water (111).

FIG. 12 also in the invention can support the use of surface treatments on the LPSP solar slats or filler slats. Such treatment can be tubes on the solar slats that let light pass, or synthetic grass bristles on the end edges of the filler slats, or short bristles to avoid blocking light on the filler slats. Or color can be made on a window covering over the LPSP itself or on solar slats.

### DETAILED DESCRIPTION

The LPSP is useful in part because it can be mounted in orientations to the sun that a traditional flat panel solar panel (FPSP) without be awkward with and large offset from the mounting surface. The LPSP benefit over becomes apparent in a vertical mounted application of FPSP that require additional mechanical supports to offset the FPSP from the mounting surfaces and their unattractive appearance on the skyline. When comparing the LPSP and the FPSP of equal panel area length times width, the LPSP uses less solar cell area or material than a FPSP when the sun rays are incident obliquely to the panel surface. This invention uses the shade from the solar slats in a novel way to provide the unexpected benefits for thermal control of the solar panel and the area behind or in-front.

Another feature of the LPSP is that it can operate without active solar cells. Since it can close while having its solar slats perpendicular to sun rays it reflects well and leaves the filler slats unexposed. The LPSP also can be designed to be an acoustic barrier by reflecting sound from the outside that comes from an angle other than perpendicular the panel. This is the case for elevated sound absorbing structures in concert halls, or windows in builds high about the sound source. This happens for buildings with floors at a height above the highway or train sound source. Absorbing material or reflector material on the solar slats and even the filler slats have advantage to reduce the sound and heat coming into the window, or absorber material to absorb sound, or sound and heat insulators. The ability to adjust the angle by closing the LPSP flat is advantages while keeping the gap closed.

The LPSP provides additional functionality over the FPSP. One is, it can also function as a sign in the vertical or near vertical cases by flipping its elements to the other side and adapting the other side with printing, lighting, or other media display techniques. The LPSP itself provide more than one type of functionality other than collecting solar energy or providing some light. The LPSP can be added to structures that provide the multiple functionalities. This invention discloses how to make a LPSP-structure for solar lawn-putting green, or deck area, or playground, sidewalk, etc., in horizontal applications. This can be implemented using the LPSP in at least two ways, and one skilled in the art may find other variants based on this disclosure but are covered in this disclosure. One, a structure is made that flips sides, one exposing the solar panels preferably the LPSP or even a FPSP, and the other side having synthetic or even living grass, or any other desirable functional or aesthetically desirable surface. The other option is to use the LPSP solar slats and filler slats flip sides where the slats are covered with the synthetic grass, living grass, or any desirable covering such as roof tile, flooring, playground covering or printing. In either case the structure or LPSP need to include supporting design features to support the weight of people walking or using the surface. In the most advanced embodiment, the LPSP-structure or even the LPSP itself can be mounted on a pedestal that rotates in azimuth to allow for sun rays to be incident perpendicular to the LPSP. The pedestal can be on an axal that rotates manually or under motorized, even be computer control to make position adjustments throughout the day.

The usefulness and new functionality of the LPSP arises because of the LPSP features that include: the slats open and close, can close nearly flat or flat, and can flip to opposite sides. When collecting light rays incident not perpendicular (obliquely) to the LPSP surface, the slats provide a gap that is useful for viewing and letting light pass through. When the solar slats are collecting obliquely, and the slats are inter-digitized with the presence of filler slats, the filler slats can close in contact with the edge of the solar slats and close-off the environment from the front. The filler slats and the solar slats can move independently, but the preferred embodiment slaves the solar slats together and filler slats together to gives independent control of both types of slats.

The solar slats are used when ideally pointed toward the sun, and the filler slats are used to open and close off the environment. Independent control is also preferred when the solar slats and filler slats are keyed with insets to allow them to close flat as in this disclose. The preferred embodiment is to use a computer processor with software, and position sensor, and power meters to control the pointing of the solar slats toward the sun.

The spacing between the slats is designed to prevent shading of solar slats as a baseline, however depending upon the application by those skilled in the art and from this disclosure can construct variations on the designs presented. In some applications, there may be shade. Fillers slats are introduced to use the area in the shade and are moved out of the way of the sun rays during collecting or are made from transparent material and may or may not be adapted with materials that change their transparency with electricity, heat, or other type of stimulus. If filler slats are not used, and all slats are solar slats, or when filler slats are used and the solar angle of the rays is out of the effective range of the LPSP design, the solar slats can become shaded. This invention includes a wiring scheme of the solar cells adapted to the solar slats, so rows of cells that become shaded are excluded from causing detrimental effects to the electric power production.

The LPSP itself can flip sides or the structure frame itself, and close flat to effect functionality changes. The LPSP can be a bill board or other sign, and flip sides to change appearance and functionality. The functionality changes by flipping sides can be to function as signage, to blend in to the environment. The solar slats are adapted with solar cells that are oriented toward the sun to collect energy. The electricity generated by the solar cells on the solar slats is routed via electric circuitry from the solar slat to the frame. Electric circuity on the solar slats or in the frame or filler slats discussed below can conditions such as stabilize or regulate the power forms of voltage and current or to convert power from voltage and current and combine the power from the solar slats to a lease one electrical output port on the LPSP. The output power is conducted away in electrical wiring for immediate consumption or to solar panel power combining station that provides power storage and/or consumption such as the utility company. The LPSP also is advantageous when the power is consumed for its alternative functionality such as cooling with a fan, or thermoelectric air conditioning. To simplify connection and plug-and play feature of replacing solar slats, a wireless charging connection between the solar slats and the frame is contemplated. To position or hold in position the solar slats in their orientation an external power supply such as solar with battery or utility supplied electricity is used motor assistance is desired. Otherwise, a mechanical linkage is provided to position the solar slats.

The solar slats may rotate to a fixed position to point toward the sun or trace the sun with a motor driving the slats, the slats may even flip to the opposite sides so the solar slat solar cells stop collecting power. In a preferred embodiment disclosed herein, the solar slat closes flat with or close against filler-slats. The LPSP can be made with or without filler slats, and either or both type of slats can flip sides to change appearance and to allow cooling and protection of the solar slats. For rays at normal incidence such as at high noon sun, the filler slats can also be adapted with solar cells.

The LPSP can be used as a replacement for traditional flat solar panels when the power is combined from the slats to be compatible or converted by power conversion circuity to be give compatible output power to a traditional panel.

This LPSP invention theoretically receives the most solar power per area of solar cells because the solar slats are oriented with their solar cell surfaces facing perpendicular (i.e., the normal vector of the solar slat solar cells is antiparallel to the sun rays.) to the sun rays and are not shadowed by the solar slats. or filler slats. To get this equivalent power, the spacing between the solar slats is the smallest distance such that they just become unshaded by adjacent solar slats. The solar slat spacing depends upon the solar design angle of the LPSP, and its orientation.

The LPSP surprisingly provides the equivalent solar power as a traditional flat solar panel (TFSP) mounted obliquely (not perpendicular) to the sun rays when the sun rays are within its effective angular range about the LPSP solar design angle. This occurs when the maximum number of solar slats per solar panel area or length are used for a specified solar design angle. The usefulness of the LPSP is it can be mounted at other angles to the sun within its effective solar angular range to get the same amount of power as a TFSP at a fixed angle mounting.

A significant advantage of the LPSP is it can be mounted at a solar angle other than its solar design angle. However, in this case, the LPSP uses less solar cell area making for case of having filler areas that can be transparent as windows or filled with filler slats. The filler slats can be adapted with coloring such a paint or colored covering, textured materials, or even lighting such as LED signage for ascetic appearance or advertising or lighting effects and ambiance. In the case without filler slats, color or texture materials, or even electrical light can be provided from the surface underneath the LPSP such as the natural roof of building.

The LPSP extremely useful because it allows solar installation design to operated effectively at other mounting angles different from that used with the TFSP. The LPSP benefit will positively impact the building and architectural designs. For example, a parking structure installation using LPSP can now reduce the roof slope of the solar roof needed to efficiently use TFSPs. Vertical mounting of windows can now be solarized with LPSPs.

The LPSP allows for more installation orientations because it is low profile and efficient over a range of effective solar angles, making it work particularly well for vertical installations as windowing and even can include a window blind or shade features. The LPSP creates electrical power by adapting the solar slats with photovoltaic semiconductor solar cells. These solar slats can also be adapted or modified to function as heat exchangers to cool the solar slat. The extracted heat can be used to heater water in a water tank or reservoir, or the air in the room behind a window adapted with the LPSP. All solar cells currently in use reduce their solar-electric efficiency with increasing temperatures. Thus, cooling with heat exchanger by conduction, air cooling convection forced or natural and liquid is advantageous. A combination of liquid or air heating and electric generation is also possible.

This is possible in this invention by running cooling liquid tubes, heat pipes on the surfaces or in channels of the solar slats. The heat can be taken out to the frame and vented or conducted to large heat sinks like windows frames that cool to the outside environment, or vent air with fans pulling cooler air over the solar slats.

An unexpected benefit of the LPSP is the solar slats provide shade to the areas between the solar slats. This makes a temperature gradient that create natural cooling by convection of the surrounding air. This is not seen with a TFSP.

The temperatures in the sun and shade can easily differ by 10 degrees or more. Using this fact, the applicant contemplates using this temperature gradient along with filler slats that close against solar slats that are collection sun is now possible to make solar air-conditioner. This would be done by placing the Peltier semiconductor elements on the filler slats in the shade with the hot side out toward the sunny side. The filler slats would have a cutout to fit the Peltier strip with heatsinks and fans. The Fans would be driven by external power or solar power from the LPSP. The air on the hot side if between a window would vent through the frame. The cool side will blow the room air across the cooling element or an adapted heat exchanges and circulate in the room with a fan on the LPSP.

The energy conducted can be stored or transfer for use immediately by the LPSP. It is disclosed herein to use the power directly to drive thermo-electric semiconductors devices such as a Peltier module to provide a heating and cooling feature of the LPSP. Another feature is to extract the electricity from the solar slats for consumption and or storage by or in devices located nearby the windows such as computer lap tops. Using the energy directly within the LPSP or nearby in an office cube behind the LPSP window installation has the advantage of eliminating or reducing the power losses due to power conversion and transmission.

CIRCUIT WIRING: In some instances when the solar angle (in zenith) is outside the intended design range, shadowing can occur on the solar slats. When the azimuth is aligned with the sun location, the LPSP shaded areas on the solar slats occurs in strips. This shading can also happen if the filler slats are not used, and only solar slats are used in a design that closes flat but has minimal gap when closed. The LPSP makes use of this shadow profile to combined more effectively the power from solar cells.

This is the case with Cehelnik's prototype 1 design. To make a solar slat we used AOSKIKE 0.5 V 400 mA 0.35 W 1.5×2 in polycrystalline silicon photocells. They were available from Amazon.com. Other solar cells work and one skilled in the art can choose components. These were wired in series of staves of 4 cell elements. Then 5 of these staves were put in series. To make a single stave for a solar slate. The output as approximately 2.0 V-3.0 volts into a 5-ohm load depending upon the solar brightness and angle. This gave a current of approximately 400 mA. Next these staves are connected to a voltage booster to 5 V. We purchased a DC-DC convertor chip that provides isolation. The voltage can also be regulated with a voltage regulator. This produces a five-volt staves. The power form the staves is combined to get the desired voltage and current of the LPSP according to the application of the power requirements. One skilled in the art can wire such to accommodate USB-C standard input power level, or any other power level.

In some instances of application, these kind of LPSP designs may still be desirable due to simplicity but will result in some of the solar slat area to be shaded, and by other solar slats. If solar cells are placed in the shaded cells are ineffective at extracting energy from the shadow and load the circuit. If the cells are wired in series and a single cell is shaded, the whole series circuit degrades its performance. Diodes are typically used to switch out shaded cells. Using diodes, usually in parallel with the cells, to switch out the shaded cells creates power loss and should be avoided when possible.

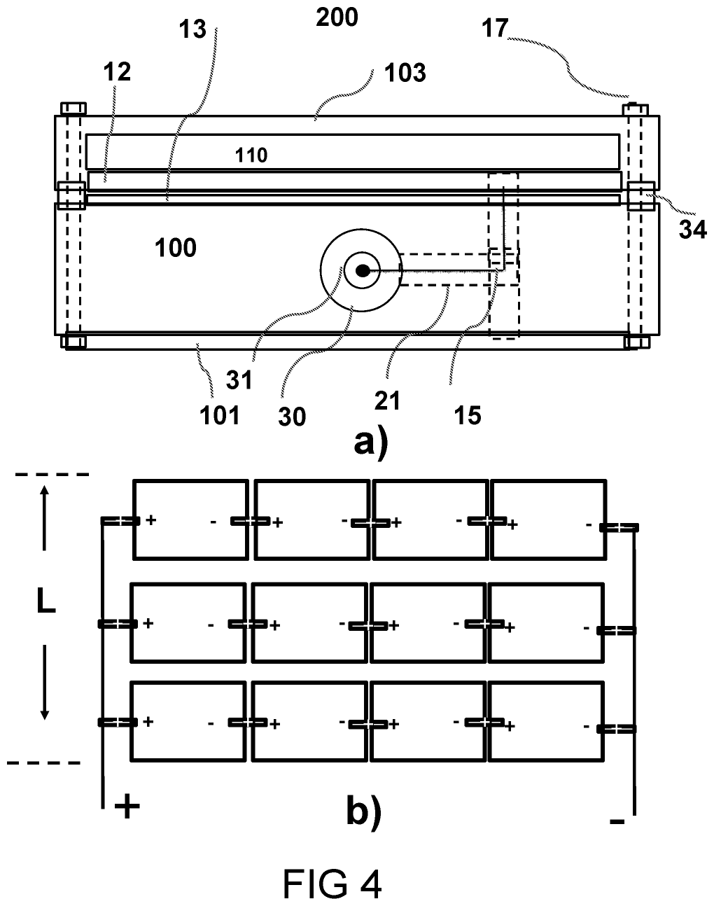

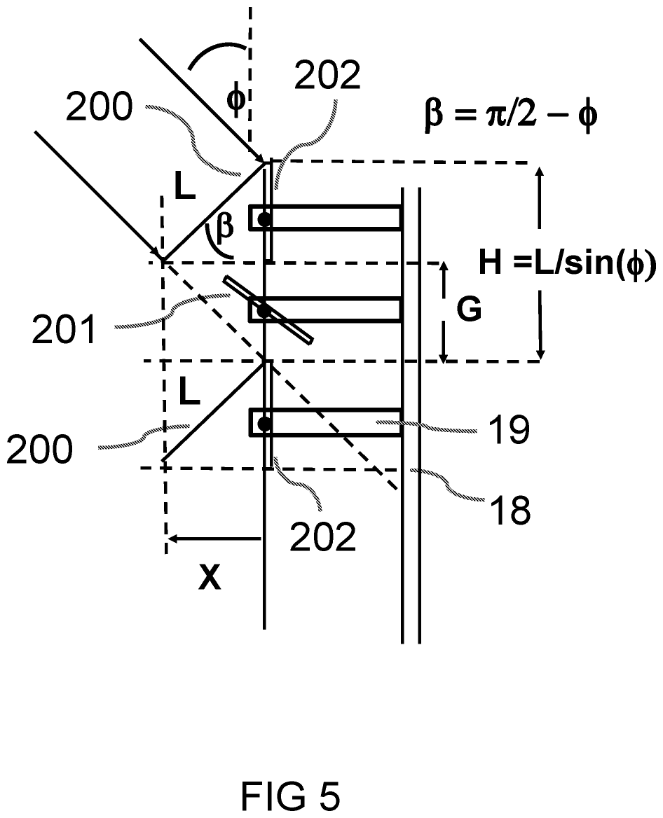

The LPSP invention avoids the loading effect of shaded strips by this problem by wiring solar cells in series in strips across the long dimension in the solar slat. This is shown in FIG. 4b). The whole strip is removed from contributing to the total solar slat power by monitoring and switching out a low power producing strip. In this way, the LPSP uses the geometry of the solar panel shade profile to reduce detrimental effects of shading. If the solar slats were wired in series in the direction that is not aligned with the shadow, all series strips would have shadows and the overall solar slat performance would be degraded. The series strips are monitored for their power production by a power sensor such a one that measuring current and voltage or another indicator of the power level being produced. The wiring circuit type in FIG. 4b) is a key feature of the LPSP to avoid shadowing.

Upon a series solar cell strip or stave passing a success power generation threshold, the electrical power is added by combination circuity. The combination circuity can be switched as needed to create the desired power levels of voltage and current by the LPSP. Each strip is regulated or boosted to a voltage within a tolerance using a boost circuit. An isolated booster is a good idea to avoid loading from the solar cells. By keeping the strips voltages regulated to the same level, they are then combined in parallel to increase the output current at the boosted voltage level. Adding more of these results in series allows the voltage to be further increased at the new current level. Using current regulator circuitry is now recommended before adding the results to get the increased output voltage. This LPSP disclosure shows how one skilled in the art of power conversion can convert the power output from the solar cell strips to get a desired power form their desired application.

The output power of the solarized slats is combined and controlled by voltage control circuity to a final output or multiple outputs on large LPSP. The output power can go to a battery or a power conditioner for use such as in notebook computer etc. Wired or Wireless coupling of power through windows and walls or solar for filler slats to the inside of the structure mounted. A converter can be a USB-C type power converter to power Office computers and devices near the windows having the LPSP installed.

The combination circuits are available that combine power from the staves, and from the solarized slats (solar and filler slats). In our prototype isolatioed DC-DC converters were used to reach a fixed voltage.

The LPSP is contemplated using a thermo-electric element such as a heater element or cooling element. This area is available area that is shaded and thus at a cooler in temperature allowing for thermal management of storages of electronics such as batteries, or use of heat exchanges in between the solar slats. the shade of the solar slats provides a cool area for heat exchanger batteries, etc. This cool area is not available without using filler slats. This is an unexpected feature or benefit of the invention that discovered after closing off the light.

The fact that this invention closes while collecting allow for unexpected benefit of temperature changes across the panel due to shade provided by the solar cell slats. This intern allows for window electronic air condition.

This LPSP invention is disruptive technology because it changes the way solar cells are thought about and used. Traditionally, glass is placed over the solar cell to make it strong and to survive the environment. Instead, the LPSP has a window supported by a frame, with sides and back in a stand-alone embodiment, and uses solar cells without glass attached to the semiconductor top. For an inside installation embodiment, the LPSP window can be simply the windows used to view out from buildings. In this case, the LPSP functions as a window blind that collects electrical energy for use or storage.

Instead, the LPSP uses an insulative thin coating of material is placed over the photovoltaic semiconductors that are put on the solar slats. This also eliminates the need to use a joining material between glass covering and the photovoltaic semiconductors. The back of the LPSP solar slats provides structurally support and electrical connectivity. This is done by using material such as circuit board material attached with a flexible joining material like those used by traditional solar cells. The circuit board includes electrical wiring for connecting individual solar cells in ways to get the desired voltage and current, and further comprises any necessary electrical circuitry and components for power conditioning.

Light diffusor or focusing lenses can be attached on the LPSP window, or be included or integrated within its window, or included in the space in-between the window and solar slats. The window can also be adapted to include coloring or camouflage effects to make the panel blend into its surroundings. These can be patterns printed on acetate or other films. The window material is chosen to pass the desired light spectrum for solar cell operation and to filter ultraviolet light from preventing damage. The window can be single or multiple layers with an optional colored or printed sign or pattern film attached to a layer places between the layers. The fact that the flutes have air causes a reflection that backlights the film making the color apparent in the sunlight. There is an unexpected angular effect that makes the film color visibly apparent from the background. The film print was made by taking a picture of the terracotta roof, making the darker edges of the roof tiles transparent by picture editing with a computer.

The solar covering for the LPSP allows for business to be done by photographing roofs or surfaces for installation and editing and making custom covers or pattern available for different surfaces. The pictures the mounting surface are uploaded to a website and edited by a program automatically or by an employee. Then printed on the film covering and attached to the LPSP window covering. A single sheet of window covering or a double sheet with the film printing placed in between. The use of ultraviolet treated plastic coverings protects the printed color or even dyes. Liquid dyes are contemplated in tubes or flutes that are over the solar cells or attached to the solar cells to provide coloring and cooling. Lensing benefits are also completed by making cylindrical lenses from tubes, or other geometric lenses placed as a covering of the LPSP or attached to the solar slats themselves.

To make the window material light, the LPSP uses fluted polycarbonate called Polygal™ but is of 8 mm, or multilayers of other thickness provided by Port Plastics in City of Industry, Calif. The flutes are filled with air or a focusing material such as liquid or clear color or colored tubing with clear liquid or colored liquid to act as a cylindrical lens. The light from all directions is focused to some focal length.

The solar slats are placed mechanically either in an optimum fixed position or mechanically adjusted to point toward the sun, either by fixed position or movable by a mechanism such as mechanical linkage like a solar blind wand, or a motor, or even a motor controlled by signal provided by a microprocessor.

In the case when the sun's rays are not incident perpendicular (oblique) to the LPSP, some open area is available between the solar slats. These areas can be occupied in this LPSP invention as filler slats. These filler slats can contain solar cell material or be covered by electrically activated tint that will change the transparency. They can be fixed or rotated. In the case when the backing of the LPSP is clear or open in a window installation, the filler slats provide a window blind function. In case, the case when a physical barrier is desired between the window, the filler slats are rotated to intercept the edges of the solar slats. Since the filler slats are mostly in the shadows of the solar slats thus providing an unexpected temperature differential between slats, there is a natural cooling of the solar slats due to convection.

The invention comprises an array of solar panel slats called solar slats along with inter-digitized filler slats. The solar slates on the outside can be open to the outside air or behind a covering window. The solar slats, filler slats or both types of slats can rotate or be fixed in angle position with respect to the sun solar angle. In a window shade application, the filler slats can rotate to avoid blocking the sun's rays from impinging on the solar slats. Alternatively, the filler slats can be transparent, or be adapted with electrically activated films (electroactive) to change the degree of transparency. The solar slats comprise structural material adapted with or containing photovoltaic material, even semi-transparent solar photo electric glass, and further comprising accompanying electrodes and wiring to conduct the generated electricity to an electrical load.

To prevent the opaque solar slats from be shaded by the filler slats, the opaque filler slats can be turned perpendicular to the solar slats. If the filler slats are turned perpendicular to the window face, the half of the filler slat on the side of the sun needs to be transparent. If the filler slats are parallel to the window face, and the sun is above the window, then the lower half of the filler slat needs to be transparent. Depending upon the application, the transparency can be made mechanically by folding the filler slat as it rotates, or by electronically using electroactive films or other means.

This can be a heat exchanges pump like air conditioner or heat pump, or electrical cooling elements such as Peltier electro-thermal generators. Additionally, because the panels close cooler temperatures make it useful to store batteries the slats out of the sun and external environment. Additionally, generated electrical power can be transferred to external sources such as the power grid through convertors, or transferred by wires or inductive coupling to other devices for consumption like cell phones, computers in the office next to the windows.

The slats can open or close mechanically by a driven mechanism such as a motor with linkage, or manually. The slats kept closed but use a non-opaque material or coating or film to allow vision or light to come through the structure. To turn off light, the material itself, or a coating or film will reaction to the material to the presence or non-presence of stimulus such as temperature, chemical such as water, or electrical power or a particular electrical signal digital or analog.

1. A structure for providing shade comprising an array of solar slates of a length Ls which is the short side length; a frame to support the slats; an orientation support for supporting the frame with the array of solar slats at a preferred orientation that may be fixed, adjustable or trackable array in azimuth, zenith, and or polar or inclination angle so it receives solar rays; a means for orientating (tilting, rotating, or pushing) the solar slats and holding the solar slats at a solar angle relative to vertical which is the zenith angle when the slats are parallel to the earths urface; and the solar angles are within an effective range so the array receives maximum solar flux; and the spacing between the solar slats H is between 1 Ls, and Hmax; where an practical upper bound on Hmax=57.299 Ls (corresponding to rays one degree off the parallel of the arrays); so that in particular
a) When the solar slat spacing of the solar slats H in the range of H=1 Ls to less than H=2 Ls so the solar slats are partially shaded; and when the solar slates are closed the gap G is in the range of 0 Ls to 1 Ls; and furthermore
when the spacing H=1 Ls the solar slats can be turned perpendicular to the solar rays at a design angle which is 0 degrees for a horizontal array and when the array is turned flat and there is no gap between the slats; but by turning the slats to a solar angle where only half of the solar slat is exposed corresponding to a solar angle for a horizontal array of 60 deg. This means the array slats may be turned to receive or solar rays perpendicular at solar angle from vertical in the range of +/−60 degrees that at least half of each solar slats is exposed all the time. This part of the slat is the piece extending above the solar plane of the array; while the exposure of the lower part will increase as the solar slats are turned to a solar angle of zero.
b) When the solar slat spacing of the solar slats H is in the range of H=2 Ls and Hmax; the full solar slats are unshaded by one another for solar angles with the effective range of solar angle; and the gap G is between 1 Ls and Hmax-Ls; and furthermore
when the spacing is H=2 Ls a horizontal array will have its solar slats completely exposed and unshaded when the solar slats are oriented to receive solar rays perpendicularly for rays incident at solar angles within a range of +/−60 degrees; and
and Hmax is less than or equal to Hs=57.299 Ls corresponding to Vertical Array with solar angle equal to 1 deg or a horizontal array with solar angle 89 deg; where the value of Hmax occurs for solar rays nearing parallel to the array and is calculated as Ls/cos(phi-alpha); and
c) The solar angles are within the effective range are defined for a solar slat spacing when the solar slats receive normal incident solar rays for case a) with at least half of the solar slat short with illuminated, and for case b) the whole slat short width is illuminated; and
c.1) the effective range is bound by a design angle producing the largest solar slat separation plus any manufacturing tolerance to just (minimally) achieve the illumination of the effective regions of the solar slats; meaning
c.2) for a design solar angle case a) H>=Ls and less than 2 Ls, the minimum solar slat spacing needed for solar rays off axis to the array face to just illuminate half of the short length of the solar slats at a solar design angle is computed as Hmin=(Ls/2)/cosine( phidesign-alpha); and
c.3) for a design solar angle case b) H>=2 Ls, the minimum solar slat spacing needed for solar rays off axis to the array face needed to illuminate the full sort width of the solar slats is computed as Hmin=(Ls)/cosine(phidesign-alpha);
[Note: For vertical design H=2 Ls, G=1 Ls corresponds to a solar angle of 30 degrees, and H=6 Ls, G=5 Ls corresponds to 9.59 deg, and H=57.299 Ls, G=56.299 Ls, corresponds to 1 deg. For A horizontal design with H=2 Ls, and G=1 Ls corresponds to a solar angle of 60 deg and 6 Ls 80.41 deg, and H=57.299 Ls, G=56,299 Ls, corresponds to a solar angle of 89.0 deg.; and a computer program in python is provided to show how to do these calculations.]

2. A Device as in claim 1 where the array comprises an energy capturing subsystem such that at least one side of the array has the solar slats at least partially adapted with a solar energy collection system such as solar panels made from photovoltaic solar cells wired to produce electricity for usage such as power combining, conversion, consumption, storage, or distribution, and or a heating and cooling thermal conduction or generating system, and or an acoustics energy/sound absorber or collector; and
a) The array flips sides exposing a surface useful for another or additional purposes other than solar energy capturing such as transforming the LPSP surface to a deck, playground, or to provide a change in appearance.

3. A Device as in claim 2 where the energy capturing system further comprises a stave (a continuous line segment or a segmented line) or solar panel subsystem, having one said stave or a plurality of said staves of solar energy collectors; and
a) The stave or the plurality of staves are spatial orientated along the long length of the solar slates to ideally be entirely illumination by solar rays or to experience shade occurring mostly along the long length of the stave. This ideal condition occurs when the rotation of the solar slats aligns with the sun in azimuth, and polar angle. Note, the polar angle is zero when the sun moves to its apex directly vertically above the array.
b) The energy or power from the stave(s) is combined to avoid loading by mostly shaded stave(s) that may occur if the array experiences shading by the solar slats by rays from solar angles within the range of effective angles when the solar slat spacing is less that 2 H; or when the solar slat spacing is greater than 2 H and the solar angle of the solar rays is outside the range of effective angles.

4. A devices as in claim 3 where the stave(s) comprise a photovoltaic solar cell or a plurality of photovoltaic solar cells for creating electrical power from the solar rays.

5. A devices as in claim 4 where:
a) The stave(s) are electrically wired solar cells or segments of solar cells wired in electrical parallel and or electrical series to achieve the desired electrical current and electrical voltage using standard solar panel such as diode blocker for series wired solar cells used in the stave(s);
b) The electrical power the solar cell adapted solar slat is obtained by combining the power from the stave(s) in a manor to isolate loading effects of lower power producing stave(s) by a stave combiner circuit. (Note: this can be electronics using threshold circuity or power sensing switches to disconnect unwanted staves, or circuity to provide power conversion, regulation, and isolation circuits, like regulators, diodes, and a DC-DC convertor.),
c) The electrical power from the array of solar cell adapted solar slats is combined using signal a solar slat combiner circuit that can just be a passive circuit such as wires alone, or wiring with passive components, or wiring with active components; and
d) The power from the solar slat and/or the combined power from the solar slat stave combiner circuit is made available for usage that includes further power combining, conversion, consumption, storage, or distribution.

6. A Device as in claim 5 where the means for orientating and holding the solar slats to the solar angle in zenith further comprising:
a. a computer program or application for providing the ephemeris data of the sun's location in azimuth angle, and zenith (solar angle from vertical) for the geolocation of the array and the time of day as average over a time period at specific positioning update time intervals; and the time is provided by a real time clock signal from a time server or clock hardware,
b. a means for providing the geolocation coordinates of the array such as from a GPS receiver antenna located near the array, a lookup table on the Internet based on the address or zip code or the array, or manual input from a map or globe to name a few.
c. a computer system (cell phone, personal computer, or microcontroller) for running/executing the computer program and for communicating with a motor control system or a servo system commands for positioning movements and for reading the position status of the solar slats from encoders; and for system feedback sensors such as power levels to ensure proper sun tracking and for checking status of power production, and for implementing failure detection and safety shutoffs from IR sensors and video camera feeds to detect intruders such as people and animals on or near the array during power production or array adjustments;
d. a linkage connecting the motor control system or servo system to position the solar slats in zenith angle; a means for orientating and holding the solar slats to the solar angle in zenith.
e. A means of providing electrical power to the computer, motors when electric, and electronics in the LPSP structure, such as batteries, electrical grid mains, and solar capture power from the solar panel.

7. A Device as in claim 6 where the array is positioned in azimuth and or polar angle and further comprises a support structure that rotates in azimuth and or the polar angle by mechanical means only or by using the computer program and computer with an azimuth and or polar motor and azimuth and or motor controller and an azimuth and or linkage such as an axial from a motor or a geared chain, or pully belt linkage. The polar angle measured from the vertical axis to a datum line parallel to the running of the solar slats.

8. A claim as in 7 where the array is circular to maintain axial symmetry during rotation in azimuth and or polar and the long length of the solar slats adjusted to make a circular shaped array of slats;

9. A claim as in 8 where the array comprises a covering to protect from the array from the environment and provide aerodynamics to either the top, back, or both sides of the array or said structure.

10. A device as in claim 5 further comprising:
A joist support system for the solar slats that provides structure support to the solar slats so it may support the weight of the array and the weight requirements to make a functional deck or play surface; where
a) the joist support system comprises an array of joists is a manual mechanical arrangement such as rotating a joist on a hinge, or a jack system where the frame of the solar slat array is lifted upward or the frame of the joist array is lowered co-joining vertical support rails to allow space for flipping of the solar array to its opposite sides to change the LPSP functionality.

11. A device as in claim 10 further comprising:
A surface treatment or a plurality of surface treatments or a covering material(s) on the opposite side such as biological plants, artificial plants and grass, artificial grass, turf, and building materials like wood, stone, playground rubber surfacing; and the covering material is at least on one side.

12. A structure for providing shade comprising an array of solar slates of short length Ls, and filler slats when appropriate of short length Lf; a frame to support the slats; an orientation support for supporting the frame with the array of solar and filler slats at a preferred orientation that may be fixed, adjustable or trackable array in azimuth, zenith, and or polar or inclination angle so it receives solar rays; a means for holding and orientating (tilting, rotating, or pushing) the solar slats and filler slats relative to vertical which is the zenith angle when the slats are parallel to the earth's surface; and the solar angles are within an effective range so the array receives maximum solar flux; and the spacing between the solar slats H is between 1 Ls and Hmax; where an practical upper bound on Hmax=57.299 Ls (corresponding to rays one degree off the parallel of the arrays); so that in particular
a) When the solar slat spacing of the solar slats H in the range of H=1 Ls to less than H=2 Ls so the solar slats are partially shaded; and when the solar slates are closed the gap G is in the range of 0 Ls to 1 Ls; and furthermore
when the spacing H=1 Ls the solar slats can be turned perpendicular to the solar rays at a design angle which is 0 degrees for a horizontal array and when the array is turned flat and there is no gap between the slats; but by turning the slats to a solar angle where only half of the solar slat is exposed corresponding to a solar angle for a horizontal array of 60 deg. This means the array slats may be turned to receive or solar rays perpendicular at solar angle from vertical in the range of +/−60 degrees that at least half of each solar slats is exposed all the time. This part of the slat is the piece extending above the solar plane of the array; while the exposure of the lower part will increase as the solar slats are turned to a solar angle of zero.
b) When the solar slat spacing of the solar slats H is in the range of H=2 Ls and Hmax; the full solar slats are unshaded by one another for solar angles with the effective range of solar angle; and the gap G is between 1 Ls and Hmax-Ls; and furthermore
when the spacing is H=2 Ls a horizontal array will have its solar slats completely exposed and unshaded when the solar slats are oriented to receive solar rays perpendicularly for rays incident at solar angles within a range of +/−60 degrees; and
and Hmax is less than or equal to Hs=57.299 Ls corresponding to Vertical Array with solar angle equal to 1 deg or a horizontal array with solar angle 89 deg; where the value of Hmax occurs for solar rays nearing parallel to the array and is calculated as Ls/cos(phi-alpha); and
c) The solar angles are within the effective range are defined for a solar slat spacing when the solar slats receive normal incident solar rays for case a) with at least half of the solar slat short with illuminated, and for case b) the whole slat short width is illuminated; and
c.1) the effective range is bound by a design angle producing the largest solar slat separation plus any manufacturing tolerance to just (minimally) achieve the illumination of the effective regions of the solar slats; meaning
c.2) for a design solar angle case a) H>=Ls and less than 2 Ls, the minimum solar slat spacing needed for solar rays off axis to the array face to just illuminate half of the short length of the solar slats at a solar design angle is computed as Hmin=(Ls/2)/cosine(phidesign-alpha); and
c.3) for a design solar angle case b) H>=2 Ls, the minimum solar slat spacing needed for solar rays off axis to the array face needed to illuminate the full sort width of the solar slats is computed as Hmin=(Ls)/cosine(phidesign-alpha);
[Note: For vertical design H=2 Ls, G=1 Ls corresponds to a solar angle of 30 degrees, and H=6 Ls, G=5 Ls corresponds to 9.59 deg, and H=57.299 Ls, G=56.299 Ls, corresponds to 1 deg. For A horizontal design with H=2 Ls, and G=1 Ls corresponds to a solar angle of 60 deg and 6 Ls 80.41 deg, and H=57.299 Ls, G=56,299 Ls, corresponds to a solar angle of 89.0 deg.; and a computer program in python is provided to show how to do these calculations.]
d) The gap when the solar slat spacing H is greater than or equal to 2 Ls is at least partially filled by a filler slat or a plurality of filler slats whereby
d.1) the filler slats rotate independently of the solar slats;
d.2) the filler slats turn perpendicular to the solar slats for a solar angle equal to the design angle; and
d.3) the filler slats make an angle larger than 90 deg with the filler slats for solar angles other than at the design angle within the effective range of solar angles.

13. A Device as in claim 12 where the array comprises an energy capturing subsystem such that at least one side of the array has the solar slats at least partially adapted with a solar energy collection system such as solar panels made from photovoltaic solar cells wired to produce electricity for usage such as power combining, conversion, consumption, storage, or distribution, and or a heating and cooling thermal conduction or generating system, and or an acoustics energy/sound absorber or collector; and
a) The array flips sides exposing a surface useful for another or additional purposes other than solar energy capturing such as transforming the LPSP surface to a deck, playground, or to provide a change in appearance.
b) 3. Device as in claim 2 where the energy capturing system further comprises a stave a continuous line segment or a segmented line) or solar panel subsystem, having one said stave or a plurality of said staves of solar energy collectors; and
c) a) The stave or the plurality of staves are spatial orientated along the long length of the solar slates to ideally be entirely illumination by solar rays or to experience shade occurring mostly along the long length of the stave. This ideal condition occurs when the rotation of the solar slats aligns with the sun in azimuth, and polar angle. Note, the polar angle is zero when the sun moves to its apex directly vertically above the array.
d) b) The energy or power from the stave(s) is combined to avoid loading by mostly shaded stave(s) that may occur if the array experiences shading by the solar slats by rays from solar angles within the range of effective angles when the solar slat spacing is less that 2H; or when the solar slat spacing is greater than 2H and the solar angle of the solar rays is outside the range of effective angles.
e) 4. devices as in claim 3 where the stave(s) comprise a photovoltaic solar cell or a plurality of photovoltaic solar cells for creating electrical power from the solar rays.

14. A device as in claim 13 where the energy capturing system further comprises a stave (a continuous line segment or a segmented line) or solar panel subsystem, having one said stave or a plurality of said staves of solar energy collectors; and
a) The stave or the plurality of staves are spatial orientated along the long length of the solar slates to ideally be entirely illumination by solar rays or to experience shade occurring mostly along the long length of the stave. This ideal condition occurs when the rotation of the solar slats aligns with the sun in azimuth, and polar angle. Note, the polar angle is zero when the sun moves to its apex directly vertically above the array.
b) The energy or power from the stave(s) is combined to avoid loading by mostly shaded stave(s) that may occur if the array experiences shading by the solar slats by rays from solar angles within the range of effective angles when the solar slat spacing is less that 2 H; or when the solar slat spacing is greater than 2 H and the solar angle of the solar rays is outside the range of effective angles.

15. A device as in claim 14 where the filler slats are at least partially covered with one said stave or a plurality of said staves of energy collectors.

16. A devices as in claim 15 where the stave(s) comprise a photovoltaic solar cell or a plurality of photovoltaic solar cells for creating electrical power from the solar rays.

17. A devices as in claim 16 where:
a) The stave(s) are electrically wired solar cells or segments of solar cells wired in electrical parallel and or electrical series to achieve the desired electrical current and electrical voltage using standard solar panel such as diode blocker for series wired solar cells used in the stave(s);
b) The electrical power the solar cell at least partially adapted solar slats, and the solar cell adapted filler slats if adapted with solar cells, is obtained by combining the power from the stave(s) in a manner to isolate loading effects of lower power producing stave(s) by a stave combiner circuit. (Note: this can be electronics using threshold circuity or power sensing switches to disconnect unwanted staves, or circuity to provide power conversion, regulation, and isolation circuits, like regulators, diodes, and a DC-DC convertor.),
c) The electrical power from the array of solar cell adapted solar slats is combined using a solar slat combiner circuit that can just be a passive circuit such as wires alone, or wiring with passive components, or wiring with active components; and
d)The electrical power from the array of solar cell adapted filler slats is combined using a filler slat combiner circuit that can just be a passive circuit such as wires alone, or wiring with passive components, or wiring with active components; and
d) The power from the solar slat and/or the combined power from the solar slat stave combiner circuit is combined with the power from the filler slat and or the combined power from the filler slat combiner, is combined by a solar-filler slat combiner circuit that can just be a passive circuit such as wires alone, or wiring with passive components, or wiring with active components made available for usage that includes further power combining, conversion, consumption, storage, or distribution.

18. A Device as in claim 17 where the means for orientating and holding the solar slats and filler slats to their respective solar angle in zenith (when the slats run parallel to the flat earth surface), further comprising:
f. a computer program or application for providing the ephemeris data of the sun's location in azimuth angle, and zenith (solar angle from vertical) for the geolocation of the array and the time of day as average over a time period at specific positioning update time intervals; and the time is provided by a real time clock signal from a time server or clock hardware,
g. a means for providing the geolocation coordinates of the array such as from a GPS receiver antenna located near the array, a lookup table on the internet based on the address or zip code or the array, or manual input from a map or globe to name a few.
h. A solar-slat motor controller, and a solar slat motor, and a solar slat linkage system to orient the solar slats;
i. A filler-slat motor controller, and a filler solar slat motor, and a filler solar slat linkage system to orient the filler slats;
j. A computer system (cell phone, personal computer, or microcontroller) for running/executing the computer program and performing communication
j.1) with the solar-slat motor control system or a solar-slat servo system to issue commands for the motor to orient the solar slats and for reading the position status of the solar slats from encoders;
j.2) with the filler-slat motor control system or a filler-slat servo system to issue commands for the motor to orient the filler slats and for reading the position status of the filler slats from encoders;
j.3) with a feedback sensor system such as power levels to ensure proper sun tracking and for checking status of power production, and for implementing failure detection and safety shutoffs from IR sensors and video camera feeds to detect intruders such as people and animals on or near the array during power production or array adjustments;
k. a solar-slat linkage connecting the solar-slat motor control system or solar slat servo system to position the solar slats in zenith angle; and for providing a means for orientating and holding the solar slats to the solar angle in zenith.
l. a filler-slat linkage connecting the filler-slat motor control system or solar slat servo system to position the solar slats in zenith angle; and for providing a means for orientating and holding the solar slats to the solar angle in zenith.
m. A means of providing electrical power to the computer, motors when electric, and electronics in the LPSP structure, such as batteries, electrical grid mains, and solar capture power from the solar panel.

19. A device as in claim 18 further comprising:
A joist support system for the solar slats that provides structure support to the solar slats so it may support the weight of the array and the weight requirements to make a functional deck or play surface; where
b) the joist support system comprises an array of joists is a manual mechanical arrangement such as rotating a joist on a hinge, or a jack system where the frame of the solar slat array is lifted upward or the frame of the joist array is lowered co-joining vertical support rails to allow space for flipping of the solar array to its opposite sides to change the LPSP functionality.

20. A device as in claim 19 further comprising:
a. A surface treatment or a plurality of surface treatments or a covering material(s) on the opposite side such as biological plants, artificial plants and grass, artificial grass, turf, and building materials like wood, stone, playground rubber surfacing; and the covering material is at least on one side.
